(19) United States
(12) Patent Application Publication
(10) Pub. No.: US 2004/0202197 A1
(43) Pub. Date: Oct. 14, 2004

(54) Mobile terminal and method of providing cross layer interaction in a mobile terminal

(75) Inventors: Xia Gao, San Jose, CA (US); Gang Wu, Cupertino, CA (US)

Correspondence Address: Brinks Hofer Gilson & Lione, NBC Tower, NBC Tower, Suite 3600, P.O. Box 10395, Chicago, IL, 60610, US

(73) Assignee: DoCoMo Communications Laboratories USA, Inc.

(21) Appl. No.: 10/409,916

(22) Filed: Apr. 8, 2003

(51) Int. Cl. H04J 3/16

(52) U.S. Cl. 370/469; 370/338; 370/328

(57) ABSTRACT

A method of providing cross layer interaction in a mobile terminal is disclosed. The method comprises the steps of providing a common policy repository in the mobile terminal; providing a system policy decision point adapted to receive policies stored is the common policy repository; and providing a layer policy decision point implementing associated with a layer. A mobile terminal enabling cross layer interaction is also disclosed. The mobile terminal comprises a policy management tool; a policy repository tool coupled to the policy management tool and storing policies generated by the policy management tool; and a policy decision point coupled to the policy management tool and the policy decision point.

### FIELD OF THE INVENTION

The present invention relates generally to mobile terminals and networks, and more particularly to a method of providing cross layer interaction in a mobile terminal.

### BACKGROUND OF THE INVENTION

Modern wireless terminals need to be programmable to support the adaptive quality of service required by multimedia applications and mobile computing users. Portable intelligent mobile devices will always have limited battery life, processing, storage and communication capability compared with desktop workstations and therefore will need to make efficient use of local resources to provide a seamless ubiquitous computing environment. Cross-layer adaptation techniques have been widely developed in order for the mobile terminals to coordinate the adaptation activities of different layers and achieve optimal system-wide performance. As more and more cross-layer techniques are to be used in a terminal, the management and unification of these diverse techniques have become a problem in wireless terminals and networks.

The desire to be connected “any time, any where, and any way” leads to an increasing array of heterogeneous systems, applications, devices and service providers. As a result, the ability to provide seamless services in such a heterogeneous environment is the key to the success of the next generation of mobile communication systems. Cross-layer adaptation algorithms are considered promising techniques to hide the complexity of the underlying heterogeneity from mobile applications. The common themes of these cross-layer adaptation algorithms are the understanding of user, application or system's performance requirements, and the adjustment of the behavior of configurable components to adapt to various heterogeneities.

The cross-layer adaptation could occur between two adjacent layers or across multiple layers. Some of the algorithms only need local information while other may need network information also. For example, one classic cross-layer adaptation technique is to adjust the behavior of TCP (transport layer) in the wireless network (link layer). Another classic example is to adjust the forwarding error correction (FEC) on the application layer to reduce wireless channel error and then further adjust link layer scheduling schemes to compensate the overhead introduced. Other examples include the reconfiguration of system processing components based on current power availability or domain information, link layer and/or physical layer control for supporting multimedia transmissions, etc.

While most of the cross-layer adaptation algorithms improve the system performance, they usually only focus on the design of the algorithm itself and the performance improvement of the applications themselves. In fact, because each of them only focuses on one aspect of the system, there is a large chance that the output of each individual algorithm may conflict with each other. Consequently, prior art systems do not unify and coordinate each individual adaptation algorithm to achieve the best overall system performance in a current environment.

While nearly all the cross-layer adaptation schemes rely on sharing important information among different layers to achieve the performance goal, most cross-layer adaptation schemes use some ad-hoc ways to exchange information between layers, such as specialized APIs or header extensions. Further, each individual cross-layer adaptation algorithm tries to adjust the actions of the components on different layers using different performance index. When multiple cross-layer adaptation algorithms coexist at the same terminal, it may not be determined how they will interact with each other. More specifically, the possible conflicts between different schemes, the validation of each scheme's assumption and the feasibility of each scheme under current running environment are not considered in conventional cross-layer adaptation algorithms.

Finally, because of the ad-hoc way of designing the cross-layer communications, the modification, extension and interconnecting of components becomes time-consuming and error-prone. Unnecessary details on each layer have to be exposed to allow little variations. In a wireless domain, the adaptation not only happens locally on one specific terminal, but also needs the coordination or cooperation from other terminals or access points. Current architectures lack the mechanism for a centralized controller, such as an access point, to dynamically manage each terminal to achieve best system-wide performance. Current International Engineering Task Force (IETF) policy framework and Internet Protocol (IP) extension header schemes target the unpredictable network environment with limited performance guarantee and complex topology. Therefore, the architecture is cumbersome and inefficient for the terminal framework.

Accordingly, there is a need for an improved mobile terminal and a method of providing a cross layer interaction in a mobile terminal.

### BRIEF SUMMARY OF THE INVENTION

The terminal device and method of the present invention provides terminal-based policy framework to achieve system-wide coordination of cross-layer adaptation algorithms. The policy framework preferably has two-level hierarchical policy decision points which operates on both system level and layer level. The system level policy decision point executes policy validation algorithms to guarantee the consistence and feasibility among policies of different algorithms, and reconfigures and modifies the support of adaptation algorithms once the policy conflicts are detected. The layer level policy decision point maintains the scalability of the system by encapsulating adaptation components and only exposing limited component information. The layer level policy decision point produce triggers of its layer requested by the system policy decision point. An abstraction of cross-layer adaptation algorithms and a specific way to use policy to express and store the algorithms is also described. A new cross-layer tag format to carry cross-layer adaptation parameters is also employed. The cross-layer tag format can be put into IPv6 extension header directly to allow end-to-end service adaptation. A shared memory is employed to upload the information from lower layer to upper layer and integrate the information into cross-layer tag. Finally, the policy choices and tag assignment during the application initialization process are described.

### BRIEF DESCRIPTION OF SEVERAL VIEWS OF THE DRAWINGS

FIG. 1 is a wireless communication network according to the present invention.

FIG. 2 is a mobile terminal according to the present invention.

FIG. 3 is a policy framework according to the present invention.

FIG. 4 is an example of a header format according to the present invention.

FIG. 5 is a cross-layer adaptation platform architecture according to the present invention.

FIG. 6 is an abstraction of a cross-layer adaptation algorithm according to the present invention.

FIG. 7 is a block diagram showing according to the present invention.

FIG. 8 is an example of a cross-layer tag format according to the present invention.

### DETAILED DESCRIPTION OF THE INVENTION

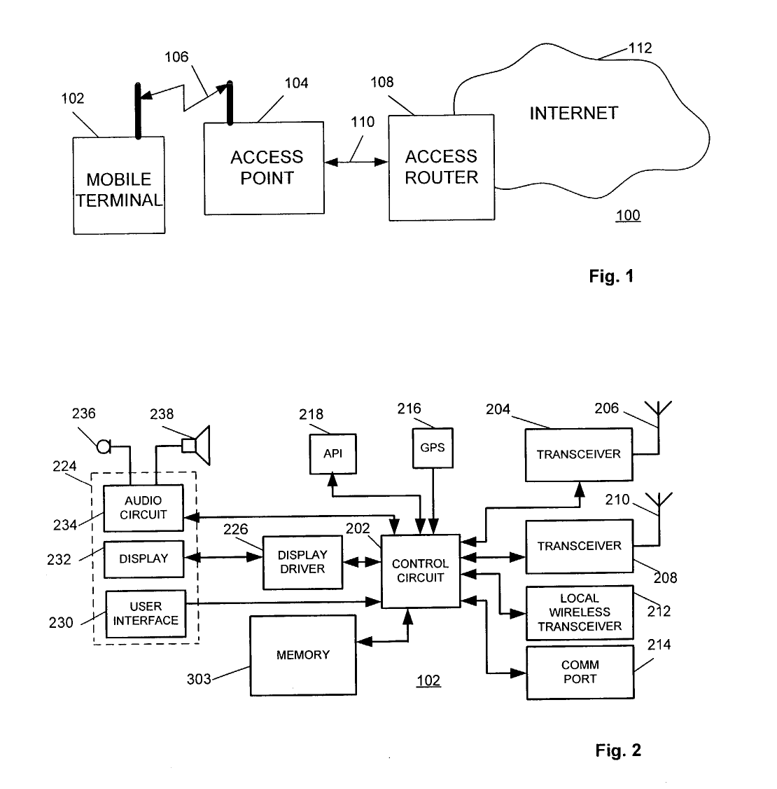

Turning first to FIG. 1, a block diagram of a conventional wireless communication network is shown. A mobile device 102 is coupled to an access point 104 by a wireless communication link 106. The access point 104 is coupled to an access router 108 by a communication link 110. The access router 108 is coupled to a communication network, such as the Internet 112.

Turning now to FIG. 2, a block diagram of a mobile device 102 according to the present invention is shown. The device preferably includes a control circuit 202, such as a microprocessor, microcontroller, ASIC or some other circuit or integrated circuit to control the device. A memory device 203 could also be coupled to the control circuit. The control circuitry 202 is also coupled to a first transceiver 204 having an antenna 206, and a second transceiver 208 have an antenna 210. The mobile device could also include a local wireless transceiver 212 for enabling low-power communications, such as infrared, Bluetooth, IEEE 802.11, etc. The mobile device can also include a communication port 214 for enabling wired communications such as RS-232 communication. The mobile device also preferably includes a GPS unit 216 enabling the reception of GPS signals. The control circuit 202 is also coupled to a user interface section 224 which preferably comprises a user interface 230, a display 232, audio circuitry 234 having a microphone to 236 and/or a speaker 238. The mobile device could be any type of wireless communication device, such as a wireless PDA or cellular telephone.

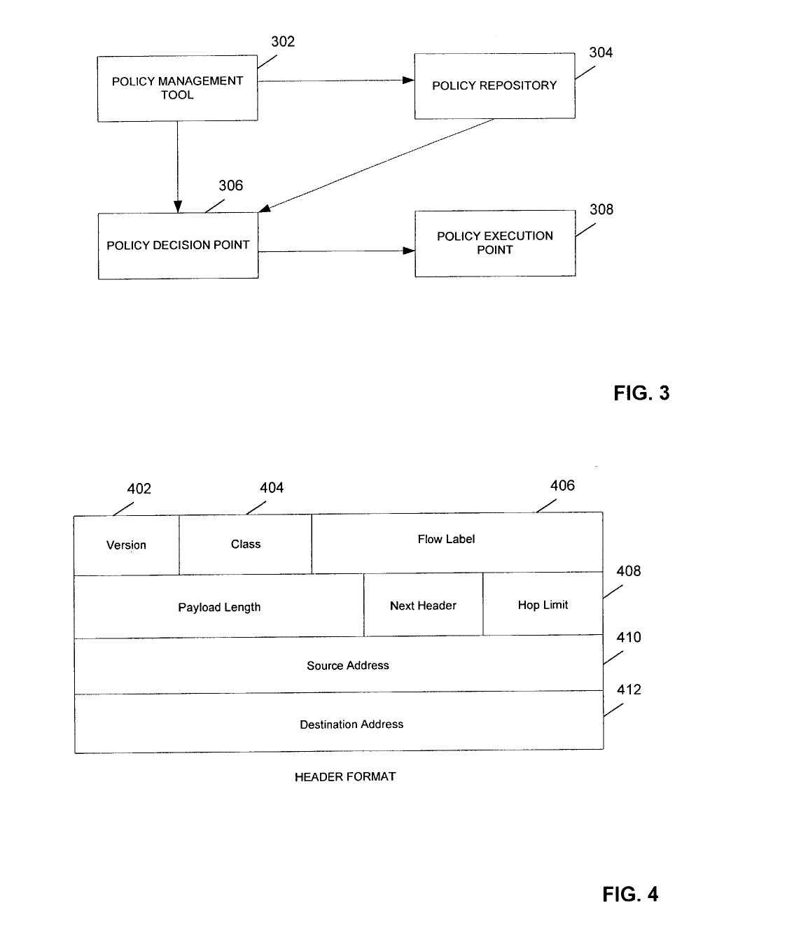

Turning now to FIG. 3, the policy framework of the present invention preferably consists of four elements: the policy management tool (PML) 302, policy repository (PR) 304, policy decision point (PDP) 306 and policy enforcement point (PEP) 308. An administrator/user uses the policy management tool to define the policies to be enforced within the network. The policies generated by PML are preferably stored in the policy repository (PR). In order to ensure interoperability across mobile terminals from different vendors, information stored in the policy repository preferably should correspond to an information model specified by the Policy Framework Working Group for the network. The PDP is responsible for retrieving the policies from the policy repository, interpreting the policies and communicating them with PEPs. The PEP is the actual device that can apply and execute the policies. The PR could be, for example, a network directory server that can be accessed by PML and PDP using Lightweight Directory Access Protocol (LDAP). The communications between PDP and PEP can use different protocols such as Common Open Policy Service (COPS) and Simple Network Management Protocol (SNMP) based on specific requirements.

The present invention could employ Internet Protocol Version 6 (IPv6). Besides enlarged address spaces, IPv6 uses more flexible and extendable header structure to expedite the processing speed of intermediate routers and easily allocate more functionality than an earlier protocol known as Internet Protocol Version 4 (IPv4). The header structure of IPv6 is shown in FIG. 4. Compared with an IPv4 header, it does some simplification by assigning a fixed format to all headers and removing the header checksum and hop-by-hop segmentation procedure. The “options” fields in IPv4 are substitute by extension headers in IPv6 that are daisy-chained together. There are two fields in the IPv6 header that were not present in IPv4, the “Class” and the “flow label”. Both are mostly designed of facilitate the handling of “real-time” traffic. The “Class” field has 8 bits. The first bit, D, is set to indicate “delay sensitive” traffic. The next three bits encode a network-wide priority level, similar to the precedence field of IPv4. These bits can be used to implement differentiated services giving priority to premium traffics. The last four bits of the field are reserved, for example congestion avoidance control.

The flow label is used to distinguish packets that require the same treatment, (i.e., data which is sent by a given source to a given destination, with a given set of options). A flow is defined as a sequence of packets sent from a particular source to a particular (unicast or multicast) destination for which the source desires special handling by the intervening routers. There is no requirement that all packets belong to flows. Rather, packets can be dynamically assigned to one flow or another based on application's preference. A flow label could have 20 bits and the packets that originate from the same source and bear the same flow label share several characteristics. Namely, the packets are (a) all bound to the same destination and should all be forwarded to the same next hop, (b) all belong to the same reservation group or queuing class, and (c) all have the same hop-by-hop options and routing header, if option or routing headers are present. Although the usage and assignment of flow labels are not standardized, it does provides finer granularity to achieve differentiated service than the flow-based or class-based schemes.

The most relevant extension header is the hop-by-hop options header (header type 00) that has the format as (<Next Header>, <Header Extension Length>, <Options>). The “Options” field contains a list of options. Each option is encoded as a variable number of octets: (<Option Type>, <Option Data Length>, <Option Data>). “Option Type” is the 8-bit identifier of the type of the option and its two high-order bits encode the action that must be taken if the processing node does not recognize the option, such as “Skip over the option” or “Discard the packet.”

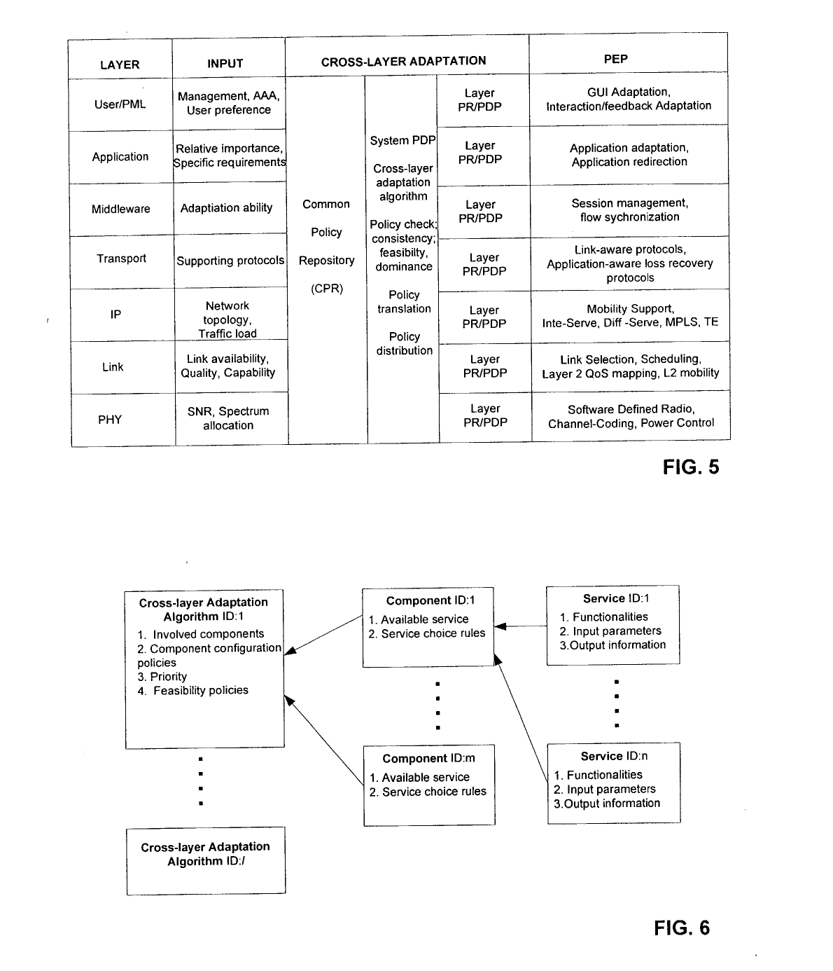

Turning now to FIG. 5, a cross-layer adaptation platform architecture according to the present invention is shown. In order to address the problems of unifying the cross-layer adaptation and communication while keeping the architecture expandable, manageable and powerful, the framework which has two interacting parts. The first part is cross-layer adaptation platform (CLAP) architecture that is based on IETF policy framework but has a new system configuration, functional components and terminal oriented design. The architecture allows centralized management, system-wide adaptation feasibility and validity check, and easy modification and extension. Working together with inter-layer tags as will be described in more detail below, the architecture of the present invention provides a unified interface for cross-layer coordination while maintaining the independence of each layer.

Before discussing in detail the CLAP architecture, the definition and expression of cross-layer adaptation algorithms will be described. Cross-layer adaptation algorithms could be defined in a hierarchical way as shown in FIG. 6. Service abstraction is used to define the behavior or functionality provided by a component. To fully specify a service, it is preferable to define (a) the functions to be defined, (b) the information (parameters) required to perform these functions, and (c) the information made available by this component to other components of the system. To support dynamic configuration, a component also needs to define (a) the service choices inside the component, and (b) the information needed to select the service. Then cross-layer adaptation algorithms could be abstracted as (a) components involved on each layer, (b) policies used to configure each component, including policy conditions using the output from some components, and policy actions using configuration parameters as the output to control some other components, (c) priority of the algorithm in case of policy conflict, and (d) assumptions of the algorithm, i.e., under which conditions the algorithm should be invoked and the assumptions are expressed as another set of policies used for coordination between algorithms.

After proper abstractions of service, component and the cross-layer adaptation algorithms, their expression as policies can be described. The method of the present invention is in line with the policy common information model (PCIM) proposed by DMTF. The information model is an abstraction and representation of the entities in a managed environment—their properties, operation, and relationships. It provides the template for specific implementations and it is independent of any specific repository, application, protocol or platform and very generic to be able to use here. Policies are generally rules governing the choices in behavior of a system. Policies define choices in behavior in terms of the conditions under which predefined operations or actions can be invoked rather than changing the functionality of the actual operations themselves. Accordingly, policies are persistent, unlike a one-time command to perform an action. A policy can be represented at different levels, ranging from business goals to layer-specific configuration parameters. Translations between different levels of representations need the knowledge of the capability of each layer's component, the policy goal of the device, and the cross-layer adaptation algorithms.

A policy rule preferably has the “If Condition then Action” semantics. A policy rule condition, in the most general cases, is preferably represented as either an ORed set of ANDed conditions (i.e. Disjunctive Normal Form, or DNF), or an ANDed set of ORed conditions (i.e. Conjunctive Normal Form, or CNF). Individual Conditions may either be negated (NOT C) or un-negated (C). Policy decision then involves two steps. The first step is the evaluation of a policy rule's condition. The second step involves the actions for enforcement when the conditions of a policy rule are TRUE. Since the condition part of the policy rules may have the output from components from different layer or some system-wide trigger such as power, location, etc, both layered PDP and system wide PDP needs to be designed to produce and transfer such condition parameters, as will be described in more detail later. Once the condition is satisfied, the action of the policy is executed that may involve the configuration of components or produce more policies. The method and apparatus of the present invention employs a hierarchical PDP architecture so that the actions of system PDP and layer PDP may not be exactly the same.

For each cross-layer adaptation algorithms, a number of policies could be produced and these policies are preferably aggregated into a Policy Group. Each Policy Group has a unique Group Identification (ID) system-wide that will be used later for applications as the index to refer to corresponding cross-layer adaptation algorithm and interpret the attached parameters. After discussing how the cross-layer adaptation algorithms are abstracted and expressed as policies, the system PDP that behaves as the centralized controller to coordinate the behavior of different cross-layer adaptation algorithms will be described. One of the main functionalities of system PDP is to validate that the output of policies of different algorithms are consistent with each other and feasible in a current environment, and to coordinate the behavior of each algorithm if necessary. The policy validation algorithms carried out by the system PDP may include following checks. A bounds check validates that the values taken by an attribute in the policy specification are within specific limits determined by the system. A relation check validates that the value taken by any two parameters in the policy specification satisfy a relationship determined by the specific algorithm. A consistency check validates that any two policies defined by different algorithms do not conflict each other. A feasibility check ensures that the policies of each algorithm are feasible under current conditions. Finally, a dominance check finds the “dominant policies” when inconsistency between policies occurs. Because some of the checks such as consistency, feasibility and dominance checks are system specific and need case-by-case treatment, we briefly discuss one implementation of how the policy can be represented in a table and then validated by computation geometry algorithms.

Policy rules still use the “If Condition then Action” semantics. When a tabular representation is used to present a policy, each input parameter of policy conditions and output of policy actions are expressed by the columns of the table, and each policy consists of one row of the table on which related columns are filled out. Then a cross-layer adaptation algorithm will be a set of rows of the table. Such a tabular expression enables some of the checks to be performed in a very simple way. For example, by associating a limit checking criteria with each column, the bound checks can be performed very easily. Relation checks can be performed by defining a relationship criteria associated with a table. Each row in the table is validated against the relationship criteria. The dominance check can be performed according to the priority attributes of the policy once the overlapping operation area has been found. The consistency checks can be done by drawing each policy's operating parameters in a hyperdimensional space. Each policy will define an area in this hyperdimensional space so that by checking whether these operation areas overlap, a conflict can be determined between different policies and algorithms. Feasibility checks can also be done by comparing output entries with system abilities.

Given the diversity of each component, the activities of PDP after detecting policy conflicts are different. If the component cannot support multiple services at the same time, (i.e. the component is stateful only), one specific policy will be installed on the component. On the other hand, if the component can support multiple services at the same time depending on some information parameters, multiple policies will be installed on the component but the polices have parameters that will be evaluated at running time. In this way, the policy framework of the present invention can avoid interference with normal data operation.

In addition to taking the cross-layer adaptation algorithms as the input and transferring them as policies stored at the common policy repository (CPR) or sending them to the layer PDPs to execute, the system PDP also takes inputs from other layers and adds management polices to the CPR. Such management policies may modify or limit the behavior of existing algorithms if needed. As shown in the column “Input” of FIG. 5, each layer may send different information to the system PDP. Such information may include the capability of the system as discussed before predefined event/trigger which needs system intervention. More generally, at the user level, a user may use policy management tool (PML) to input high-level policies such as user preference, service level agreement, business goal, security, or environment parameters. The policies may be expressed in terms of a language closer to the natural communications rather than in terms of the specific technology implementing it. Such high-level policies at first have to be checked to ensure the consistency, correctness and feasible, and then translated to technology oriented policies stored in the CPR also. More generally, the present invention can easily allow remote configuration and adaptation by taking remote control policies into account.

Such newly added policies have to be compared with existing cross-layer adaptation policies also to find out whether conflicts can happen. If so, new policies have to be added to the CPR to guide the system how to operate in such cases. This may lead to new policies to be installed in the layer PDP and PR also. The comparison between high-level polices and cross-layer adaptation policies can be expedited by the usage of “feasibility polices” in the algorithm abstraction shown in FIG. 6.

Each cross-layer adaptation algorithm expresses its assumption of surrounding environment and limitations. For elements not covered in these policies, some default or observed values could be used. An extra event or error trigger could also be implemented also. System PDP could work together with layered PDP to define the globally important information that should be reported by the layered PDP. Such information could include the change of location, network or current battery capability. Such parameters are important in terms of system performance and will lead to system reconfiguration if triggered.

The update of already installed policies in the layer PDP and PEP can be speeded up by using “enable” attributes included in each policy rules. Basically, each algorithm's policies need not be uninstalled or substituted by other policies. By simply resetting the “enable” attributes, the system PDP can easily and flexibly change the support for one specific algorithm. Furthermore, the application does not need to be changed. It still uses the same policy group number although the support is no longer the same.

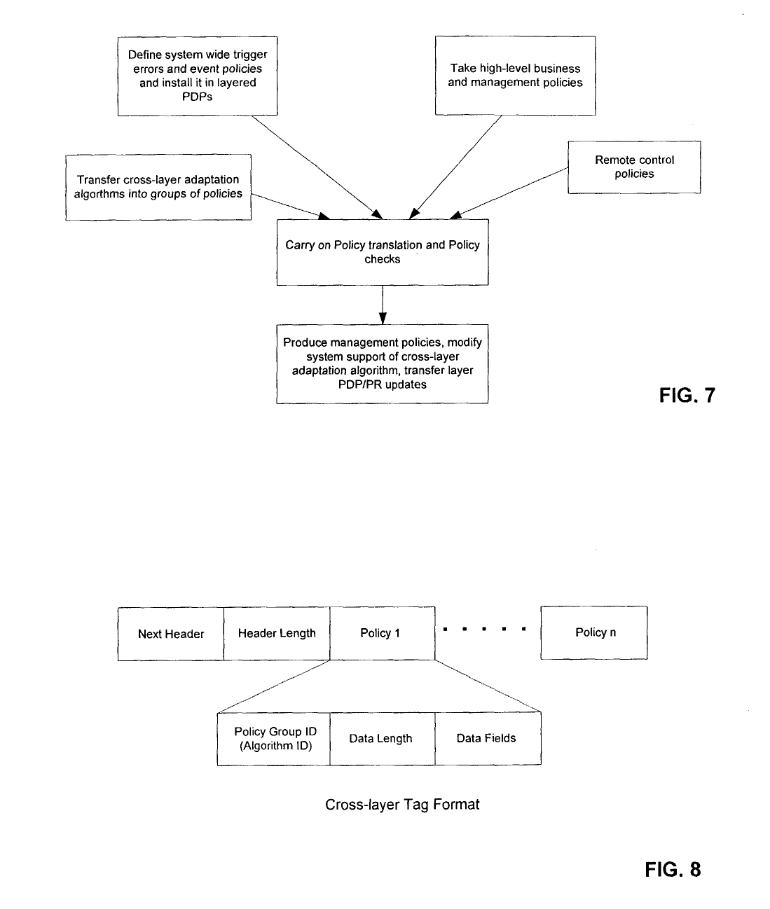

To summarize the important functionalities of the system PDP, we include the general running sequence of the system PDP in FIG. 7. Our architecture has hierarchical PDP setup to keep the transparency of each layer and make the system scalable, flexible and easy to manage. As shown in FIG. 5, the PEPs of each layer are the components involved in the cross-layer adaptation algorithm and have the abstraction as shown in FIG. 6. Each PEP is controlled by the layer PDP on its own layer and can install policies locally. For PEPs supporting multiple functions at the same time, the PEPs could evaluate the parameter values specified by the policies and invoke corresponding procedure. Each PEP could collect and output policy-specified statistics and parameters for cross-layer coordination. Local PR only maintains local policies which are either produced by local PDP or transferred from the system PDP.

Local PDP is a key element of the structure to allow appropriate operation of the system. The local PDP maintains local adaptation abilities. Therefore, not all the adaptation ability needs to be cross-layer so the local PDP is in charge of coordinating adaptation on its own layer. Furthermore, because local adaptation may also influence the components which are part of cross-layer components, the local PDP can implement local policy checks to guarantee the policy consistency. As terminals become more and more complicated and cross-layer adaptation techniques keep improving, more components of one layer will participate into the cross-layer coordination. To make the system scalable and extendable, local PDP could choose to only expose limited components to the system PDP by encapsulating these components.

As discussed before, the system PDP could work together with local PDP to define important triggers on each layer. Such triggers are not for performance adaptation, but for system wide reconfiguration or modification. Cross-layer adaptation algorithms need two types of support from the system. The first type of support is to dynamically choose services from the same component and guarantee the system-wide feasibility, which has been supported by our CLAP architecture shown in FIG. 3.

The second type of support is to support cross layer information exchange. Because this is application specific and flow-based, which should not by the policy framework itself. Considering this, we include the data structure of “cross-layer Tag” (CLT) similar to IPv6 extension header to achieve cross-layer information exchange.

By using the same fields such as “next header” and “header length”, the CLT can be integrated into the IPv6 header and sent out to the remote host. In this case, the CLT header type could be zero, the same as “hop-by-hop” header in IPv6, or be sixty, the same as “destination option” header in IPv6. This then serves as a mechanism to carry the end-to-end adaptation parameters to the communicating nodes. Depending on specific algorithm, the CLT itself or some modification can be used in the end-to-end communication. Each CLT can have multiple policy fields which all have the same format of <policy group ID, data length, data fields>. Because each cross-layer adaptation algorithm has been assigned a unique policy group ID, the policy ID is used as the index by the PEPs on each layer to understand the usage and format of data in the data fields. To allow parameters with variable length, “data length” field is used. Based on the application requirements and system capability, one or more cross-layer adaptation algorithm could be used by one application. Because system PDP has guaranteed the consistency of each policy and modified the policy support if needed, applications are released of such burdens. Data fields contains both normal data types such as string, integer, Boolean, or float numbers, and specific location pointers for cross-layer data uploading.

For information exchanges from an upper layer to the lower layer, CLT could be appended to the normal packets and processed by related components. But for information uploaded from a lower layer to an upper layer, such channel may not exist. So the system allocates a shared memory area in Common Policy Repository (CPR) to allow such information exchange. During the application initialization period, when the adaptation policies are chosen, the related parameter exchange can be decided so that if an uploading channel is necessary, a piece of shared memory is assigned and the pointer is returned. The shared memory is indexed by the unique FlowID or ProcessID. The pointer is then included in the CLT data fields and received by the PEPs. Then PEPs can use the pointer to access the memory to exchange information with upper layer components.

One of the functionalities of user/application layer PEPs is to maintain and assign appropriate Policy Group ID to each application. Because the policy granularity could be an application, a flow, or a group of packets, we propose the usage of FlowID field in IPv6 that supports flexible granularity adjustment. The application layer PEP collects the information of application, checks the cross-layer adaptation algorithm availability (which are modified by system PDP) and matches the policies with application's requirements. The flow chart of the initialization of an application is shown in FIG. 7.

By carefully studying the pitfalls of existing cross-layer adaptation algorithms, the method and apparatus of the present invention adopts and extends the policy framework to allow unified system-wide adaptations. With newly designed hierarchical policy decision points (PDP) operating on system level and layer level, our architecture guarantees the consistency among all the adaptation algorithms and maintains the transparency and scalability of the system.

In summary, the method and apparatus of the present invention provides system-wide coordination among cross-layer adaptation algorithms. The framework represents the cross-layer adaptation algorithm as a set of policies that are defined as relationships between corresponding components. Then system-level policy decision point executes the policy validation algorithms to guarantee the consistency among different adaptation algorithms. The method and apparatus also provides transparency of different layers. By utilizing hierarchical policy decision point operating on both system level and layer level, the transparency is maintained by the well-defined interface between two-level policy decision points. The method and apparatus also provides a flexible architecture. The architecture allows the policies from user, different layers or remote controller to be integrated into the framework. It separates the algorithm choices and algorithm support. While applications are given the flexibility to choose adaptation algorithms, the PDPs are allowed to change the mechanisms to support the policies based on current status. After the structure has been built into the system, new addition of algorithm becomes straightforward by simply expressing the algorithm as a set of policies and presenting the set of policies to the structure to process. No additional modification of cross-layer API is needed. Our architecture only uses policy framework to configure the adaptation components and guarantee the consistency among different algorithms. It does not intend to provide flow-level by itself to increase the scalability of the system. The flow-level adaptation is supported by integrating parameterized policy evaluation at PEPs and cross-layer tags carried by each flow. New cross-layer tag architecture is proposed to unify the information exchange from upper layer to lower layer. The tag also has the pointer to a piece of shared memory to allow information uploaded from lower layer to upper layer if necessary. To be integrated with end-to-end adaptation techniques, the cross-layer tag has the similar format as IPv6 extension header to be easily appended to IPv6 headers to carry adaptation information end-to-end.

It can therefore be appreciated that the new and novel method of providing cross-layer action in a mobile terminal has been described. It will be appreciated by those skilled in the art that, particular the teaching herein, numerous alternatives and equivalents will be seen to exist which incorporate the disclosed invention. As a result, the invention is not to be limited by the foregoing embodiments, but only by the following claims.

1. A method of providing cross layer interaction in a mobile terminal, said method comprising the steps of:
providing a common policy repository in said mobile terminal;
providing a system policy decision point adapted to receive policies stored in said common policy repository; and
providing a layer policy decision point implementing associated with a layer.

2. The method of providing cross layer interaction in a mobile terminal of claim 1 further comprising a step of providing a layer policy repository.

3. The method of providing cross layer interaction in a mobile terminal of claim 1 further comprising a step of providing a policy execution point.

4. The method of providing cross layer interaction in a mobile terminal of claim 1 wherein said step of providing a policy execution point comprises providing a policy execution point for a plurality of layers of said mobile terminal.

5. The method of providing cross layer interaction in a mobile terminal of claim 1 further comprising a step of providing a cross layer tag.

6. The method of providing cross layer interaction in a mobile terminal of claim 1 further comprising a step of providing a block of shared memory for some applications.

7. The method of providing cross layer interaction in a mobile terminal of claim 1 wherein said step of providing a system policy decision point comprises a step of storing a plurality of cross layer adaptation algorithms expressed as polices in the said common policy repository.

8. The method of providing cross layer interaction in a mobile terminal of claim 1 wherein said step of providing a system policy decision point comprises a step of providing a cross layer configuration policies to configure a plurality of layer policy decision points.

9. The method of providing cross layer interaction in a mobile terminal of claim 1 wherein said step of providing a system policy decision point comprises a step of providing policy checks.

10. The method of providing cross layer interaction in a mobile terminal of claim 1 wherein said step of providing a system policy decision point comprises a step of providing a policy translation.

11. The method of providing cross layer interaction in a mobile terminal of claim 1 wherein said step of providing a system policy decision point comprises a step of providing policy distribution.

12. A method of providing cross layer interaction in a mobile terminal, said method comprising the steps of:
identifying a plurality of service performed in said mobile terminal;
identifying a plurality of components providing predetermined service of said plurality of service; and
providing a cross layer adaptation algorithm associated with predetermined components of said plurality of components.

13. The method of providing cross layer interaction in a mobile terminal of claim 12 wherein said step of identifying a plurality of service performed in said mobile terminal comprises a step of defining functions of a service.

14. The method of providing cross layer interaction in a mobile terminal of claim 12 wherein said step of identifying a plurality of service performed in said mobile terminal comprises a step of defining input parameters to perform the function.

15. The method of providing cross layer interaction in a mobile terminal of claim 12 wherein said step of identifying a plurality of service performed in said mobile terminal comprises a step of defining information made available to components of the system.

16. The method of providing cross layer interaction in a mobile terminal of claim 12 wherein said step of identifying a plurality of components providing predetermined service of said plurality of service comprises a step of defining available services within the component.

17. The method of providing cross layer interaction in a mobile terminal of claim 12 wherein said step of identifying a plurality of components providing predetermined service of said plurality of service comprises a step of defining information needed to select the service.

18. The method of providing cross layer interaction in a mobile terminal of claim 12 wherein said step of providing a cross layer adaptation algorithm associated with predetermined components of said plurality of components comprises a step of identifying components involved in each layer.

19. The method of providing cross layer interaction in a mobile terminal of claim 12 wherein said step of providing a cross layer adaptation algorithm associated with predetermined components of said plurality of components comprises a step of determining policies to configure each component.

20. The method of providing cross layer interaction in a mobile terminal of claim 12 wherein said step of providing a cross layer adaptation algorithm associated with predetermined components of said plurality of components comprises a step of establishing a priority of the algorithm in the event of a priority conflict.

21. The method of providing cross layer interaction in a mobile terminal of claim 12 wherein said step of providing a cross layer adaptation algorithm associated with predetermined components of said plurality of components comprises a step of establishing policies for establishing coordination between algorithms.

22. A method of providing cross layer interaction in a mobile terminal, said method comprising the steps of:
producing management policies in a system policy decision point of said mobile terminal;
producting coordination policies to coordinate cross layer adaptation algorithms in the common policies repository based upon said management policies; and
transferring said cross layer coordination policies to layer policy decision points.

23. The method of providing cross layer interaction in a mobile terminal of claim 22 further comprising a step of performing policy checks.

24. The method of providing cross layer interaction in a mobile terminal of claim 22 further comprising a step of transferring cross-layer adaptation algorithms into groups of policies.
The method of providing cross layer interaction in a mobile terminal of claim 22 further comprising a step of providing coordination functions to solve the conflicts among cross layer adaptation algorithms.

25. The method of providing cross layer interaction in a mobile terminal of claim 22 further comprising a step of defining system wide triggers, errors or events.

26. The method of providing cross layer interaction in a mobile terminal of claim 25 further comprising a step of managing each layer's point decision point to transmit said triggers, errors or events to system decision point.

27. The method of providing cross layer interaction in a mobile terminal of claim 22 further comprising a step of receiving remote control policies.

28. The method of providing cross layer interaction in a mobile terminal of claim 22 further comprising a step of user management or preference policies input through policy management tool.

29. A method of providing cross layer interaction in a mobile terminal, said method comprising the steps of:
establishing a policy group ID for policies of each cross layer adaptation algorithm;
producing a plurality of management policies in a system policy decision point of said mobile terminal;
establishing a policy group ID for each said management policy; and
transferring said plurality of management policies from system policy decision point to a plurality of layer policy decision points.

30. The method of providing cross layer interaction in a mobile terminal of claim 29 further comprising a step of providing a data length and a data field associated within each cross layer tag.

31. The method of providing cross layer interaction in a mobile terminal of claim 29 further comprising a step of collecting information of an application at an application layer policy execution point.

32. The method of providing cross layer interaction in a mobile terminal of claim 29 further comprising a step of checking the cross layer adaptation algorithm availability.

33. The method of providing cross layer interaction in a mobile terminal of claim 29 further comprising a step of matching the requirements of an application with a policy.

34. The method of providing cross layer interaction in a mobile terminal of claim 29 further comprising a step of using cross layer tag to carry information used in each layer to make the service choices.

35. The method of providing cross layer interaction in a mobile terminal of claim 29 further comprising a step of using shared memory to upload from lower layer to upper layer the information used in each layer to make the service choices.

36. The method of providing cross layer interaction in a mobile terminal of claim 29 further comprising a step of integrating cross layer tag with end-to-end information exchange.

37. A mobile terminal enabling cross layer interaction, said device comprising:
a policy management tool;
a policy repository tool coupled to said policy management tool and storing policies generated by the policy management tool; and
a policy decision point coupled to said policy management tool and said policy decision point.

38. The mobile terminal of claim 37 further comprising a plurality of policy repositories associated with a plurality of layers of said mobile terminal.

39. The mobile terminal of claim 37 further comprising a plurality of policy decision points associated with a plurality of layers of said mobile terminal.

40. The mobile terminal of claim 37 further comprising a policy execution point coupled to said policy decision point.

41. The mobile terminal of claim 37 further comprising a plurality of policy execution points associated with a plurality of layers of said mobile terminal.

42. The mobile terminal of claim 37 further comprising a cross layer tag sent between layers of said mobile terminal.

43. The mobile terminal of claim 42 wherein said cross layer tag comprises information used by a plurality of policies.

44. The mobile terminal of claim 43 wherein each policy of said plurality of policies comprises a policy group identification.

45. The mobile terminal of claim 44 wherein each cross layer tag comprises a data length field.

46. The mobile terminal of claim 45 wherein each cross layer tag comprises a data field.
